(19) United States
(12) Patent Application Publication
(10) Pub. No.: US 2006/0288274 A1
(43) Pub. Date: Dec. 21, 2006

(54) System for creating markup language documents at a receiving display station having multiple contexts from multiple secured sources on a communication network, e.g. the web with visual indicators for identifying content and security

(76) Inventors: Leugim A. Bustelo, Austin, TX (US); Andrew Douglas Hately, Austin, TX (US); Julio Eloy Ruano, Round Rock, TX (US)

Correspondence Address: IBM CORPORATION;INTELLECTUAL PROPERTY LAW, 11400 BURNET ROAD, AUSTIN, TX, 78758, US

(21) Appl. No.: 11/154,901

(22) Filed: Jun. 16, 2005

(51) Int. Cl. G06F 17/24

(52) U.S. Cl. 715/513

(57) ABSTRACT

Creating a markup language hypertext document having multiple contents, respectively, from multiple sources comprising an implementation for providing multiple contents for a created markup language hypertext document from a plurality of sources including said interactive display stations, and for tracking the source of each of the multiple contents in the created hypertext document. Then, there is an implementation for displaying the created hypertext document at an interactive network, e.g. World Wide Web display station, combined with showing the source of each of said multiple contents in the displayed hypertext document by a non-alphanumeric visual indicator, which may be a preselected color. The color indicator may be indicative of the security type and level of the content source and, thus, the content. The security level may be determined by the electronic signature of the source content, e.g. an XML signature.

### TECHNICAL FIELD

The present invention relates to a system, method and program for creating markup language documents, the contents of which are obtained from multiple sources from computer networks, such as the World Wide Web (Web) or Internet.

Background of Related Art

The past decade has been marked by a technological revolution driven by the convergence of the data processing industry with the consumer electronics industry. The effect has driven technologies that have been known and available and relatively quiescent over the years. Two of these technologies are the Internet related distribution and object oriented programming systems. Both of these technologies are embodied in the use of object oriented technology and the Java programming system, in particular, for a wide variety of consumer and business purposes over the Internet or Web or like private networks. For details and background with respect to the Java system, reference may be made to a typical text, Just Java, 2nd Edition, Peter van der Linden, Sun Microsystems, 1997. With the development and rapid expansion of the Web and other like networks, hypertext markup languages became the primary vehicle for distribution of data over such networks. A basic hypertext language, HTML, is described in detail in the above-entitled Just Java text, particularly at Chapter 7, pp. 249-268, dealing with the handling of Web pages; and also in the text, Mastering the Internet, G. H. Cady et al., published by Sybex Inc., Alameda, CA, 1996, particularly at pp. 637-642, on HTML in the formation of Web pages. The Web pages are implemented so as to be used for the distribution of Web documents containing text, images, both still and moving, and sound, as well as programs.

The rapid expansion of people, businesses and organizations with Web or Internet (used interchangeably) access, has resulted in the widespread use of the Web for business, e.g. e-business and like electronic business, educational, medical and legal transactions. The complexity of the interrelationships involved in these transactions has made it common to handle and distribute Web or like private network documents having multiple contents respectively from multiple sources on the network. Such sources may be individual users at network display stations, as well as network databases that provide already developed and stored content. With the greater reliance on the impersonal network communication, there is less personal contact between the contributors of the content of these network documents. This makes it much harder for a participating user in a network transaction to recognize who contributed what to the document. There is also the issue of security. Since the participating users cannot directly recognize who made the content contributions, there is a need for an easy to use means for defining the specific contributors for each content in a multiple content document, as well as the security status of each of the multiple contents.

### SUMMARY OF THE PRESENT INVENTION

The present invention offers an implementation for a user at a network display station who is reviewing or developing a network, e.g. Web document, that will easily indicate the source of each content in a multiple content displayed document. In accordance with another aspect, the invention will provide an indication of the security level of the content source through the visual indicator.

Accordingly, there is provided a system for creating markup language, e.g. hypertext documents having multiple contents, respectively, from multiple sources comprising means for providing multiple contents for a created hypertext markup language document from a plurality of sources including said interactive display stations, and means for tracking the source of each of said multiple contents in said created HTML markup language document. Then, there are means for displaying said created HTML document at an interactive network display station, combined with means for showing the source of each of said multiple contents in said displayed HTML document by a non-alphanumeric visual indicator, which may be a preselected color.

The color indicator may be indicative of the security type and level of the content source and, thus, the content. As will be described hereafter in greater detail, the security level may be determined by the electronic signature of the source content. According to a specific aspect of the invention, the electronic signature of the HTML document is created with XML protocols and the electronic signature is an XML signature that will hereinafter be described in greater detail.

### BRIEF DESCRIPTION OF THE DRAWINGS

The present invention will be better understood and its numerous objects and advantages will become more apparent to those skilled in the art by reference to the following drawings, in conjunction with the accompanying specification, in which:

FIG. 1 is a block diagram of a data processing system including a central processing unit and network connections via a communications adapter that is capable of functioning both as a server computer and a client display station in the network of the present invention;

FIG. 2 is a generalized diagrammatic view of a network portion, i.e. a server computer connected to a Web portion, to illustrate how the present invention provides visual indicators to distinguish each of the multiple contents in the hypertext document having multiple contents;

FIG. 3 is an illustrative interactive display showing an illustrative page of a Web document to illustrate how the present invention distinguish each of the multiple contents in the hypertext document having multiple contents;

FIG. 4 is an illustrative flowchart describing the setting up of the elements of the present invention for the distinguishing of each of the multiple contents in the hypertext document having multiple contents; and

FIG. 5 is a flowchart of an illustrative run of the program set up in FIG. 4.

### DETAILED DESCRIPTION OF THE PREFERRED EMBODIMENT

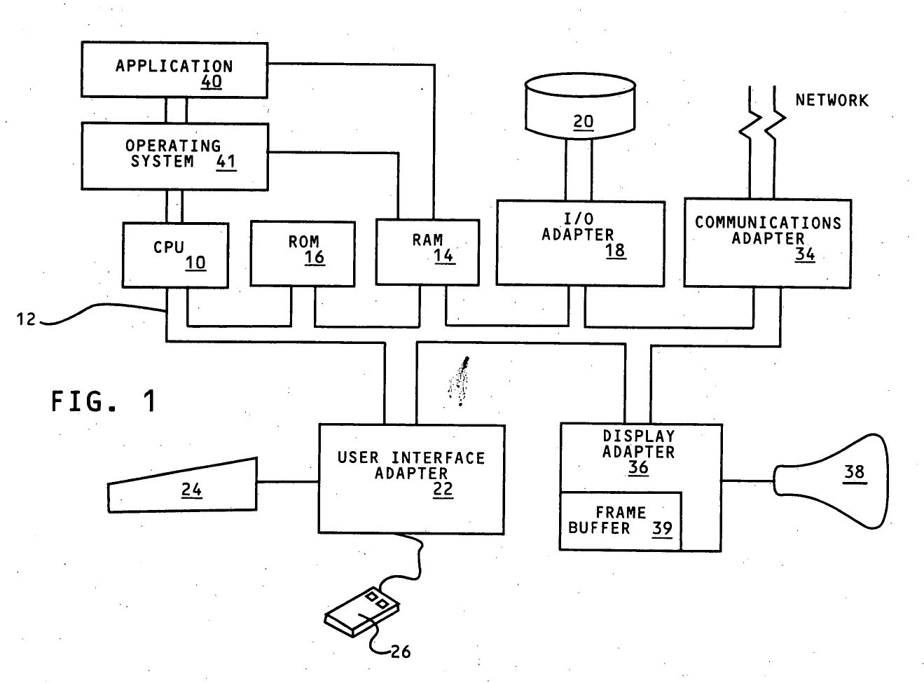

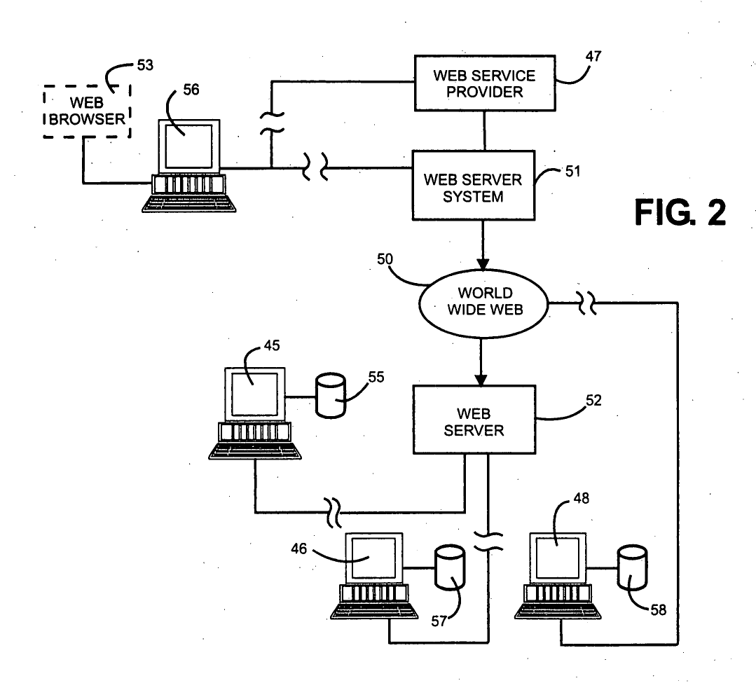

Referring to FIG. 1, a typical data processing unit is shown that may function as the network display stations used for receiving the Web documents having the multiple contents, respectively, from multiple sources or function as the Web or network server computers for accessing each of the multiple contents from their sources on the Web in the present embodiment wherein the Web is the illustrative network. A central processing unit (CPU) 10, such as one of the PC microprocessors or workstations, available from International Business Machines Corporation (IBM) or Dell PC microprocessors, is provided and interconnected to various other components by system bus 12. An operating system 41 runs on CPU 10, provides control and is used to coordinate the function of the various components of the computer of FIG. 2. Operating system 41 may be one of the commercially available operating systems, such as IBM's AIX or Microsoft's WindowsMe™ or Windows 2000™, as well as UNIX and other IBM AIX operating systems. Application programs 40, controlled by the system, are moved into and out of the main memory Random Access Memory (RAM) 14. These programs include the object oriented programs of the present invention for accessing of the multiple contents from the Web and forming the multiple contents HTML display documents wherein the sources of the multiple contents are distinguished by visual indicators, such as color, on the display screens of the receiving Web stations. These functions will be described hereinafter in combination with conventional Web browsers (browsers 53, FIG. 1) at Web display stations 56 (FIG. 1), such as Microsoft's Internet Explorer™. A Read Only Memory (ROM) 16 is connected to CPU 10 via bus 12 and includes the Basic Input/Output System (BIOS) that controls the basic computer functions. RAM 14, I/O adapter 18 and communications adapter 34 are also interconnected to system bus 12. I/O adapter 18 may be a Small Computer System Interface (SCSI) adapter that communicates with the disk storage device 20. Communications adapter 34 interconnects bus 12 with an outside network. I/O devices are also connected to system bus 12 via user interface adapter 22 and display adapter 36. Keyboard 24 and mouse 26 are all interconnected to bus 12 through user interface adapter 22. It is through such input devices that the user at the Web display stations may interactively relate to the Web server programs for providing the hypertext documents of the present invention wherein color indicators distinguish the multiple contents from multiple sources from each other.

Display adapter 36 includes a frame buffer 39 that is a storage device that holds a representation of each pixel on the display screen 38. Images may be stored in frame buffer 39 for display on monitor 38 through various components, such as a digital to analog converter (not shown) and the like. By using the aforementioned I/O devices, a user is capable of inputting information to the system through the keyboard 24 or mouse 26 and receiving output information from the system via display 38.

A generalized example of the practice of the present invention involving the use of visual indicators, e.g. colors, to distinguish the respective multiple contents in displayed network documents formed from corresponding multiple sources will be considered with respect to FIG. 2 that shows a generalized portion of the Web that serves as the illustrative communication network in this embodiment of the present invention. First, it should be helpful to understand from a more general perspective the various elements and methods that may be related to the present invention. Since the present invention involves Web hypertext documents, formed by multiple contents, respectively, from multiple sources on the Web, an understanding of the Web and its operating principles would be helpful. Reference has also been made to the applicability of the present invention to a global network, such as the Internet or Web. For details on Internet nodes, objects and links, reference is made to text, Mastering the Internet, G. H. Cady et al., published by Sybex Inc., Alameda, Calif., 1996. (Web and Internet are used interchangeably in this description.)

The Internet or Web is a global network of a heterogeneous mix of computer technologies and operating systems. Higher level objects are linked to lower level objects in the hierarchy through a variety of network server computers. These network servers are the key to network distribution, such as the distribution of Web pages and related documentation.

Web documents are conventionally implemented in HTML language, which is described in detail in the text, Just Java, 2nd Edition, Peter van der Linden, Sun Microsystems, 1997, particularly at Chapter 7, pp. 249-268, dealing with the handling of Web pages; and also in the text, Mastering the Internet, particularly at pp. 637-642, on HTML in the formation of Web pages. In addition, aspects of this description will refer to Web browsers. A general and comprehensive description of browsers may be found in the above-mentioned Mastering the Internet text at pp. 291-313. More detailed browser descriptions may be found in the text, Internet: The Complete Reference, Millennium Edition, M. L. Young et al., Osborne/McGraw-Hill, Berkeley Calif., 1999, Chapter 19, pp. 419-454, on the Netscape Navigator; Chapter 20, pp. 455-494, on the Microsoft Internet Explorer; and Chapter 21, pp. 495-512, covering Lynx, Opera and other browsers.

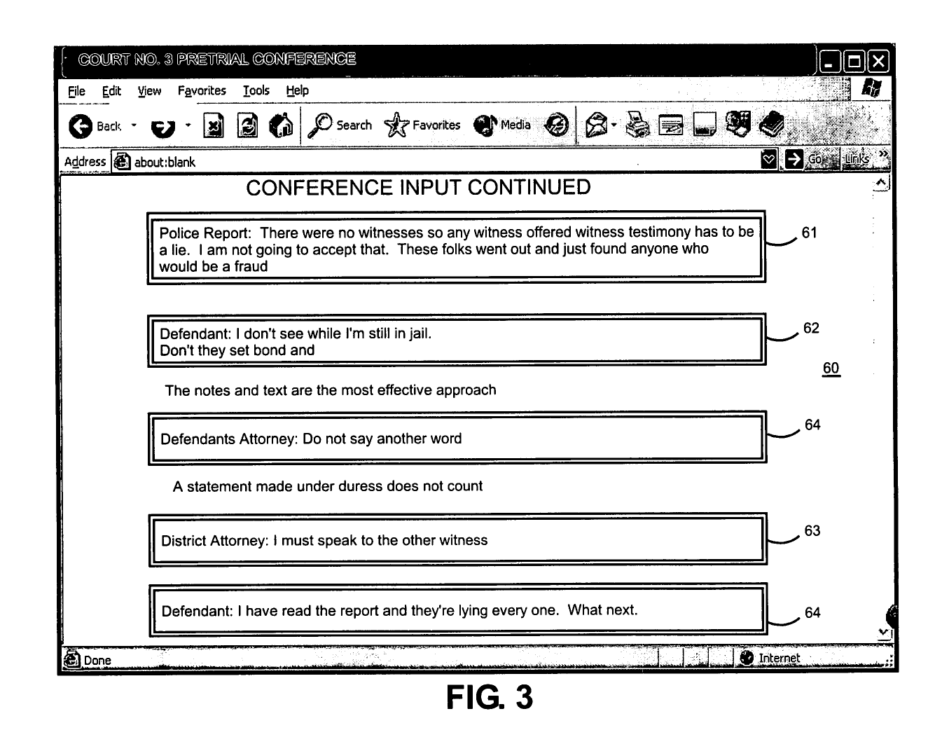

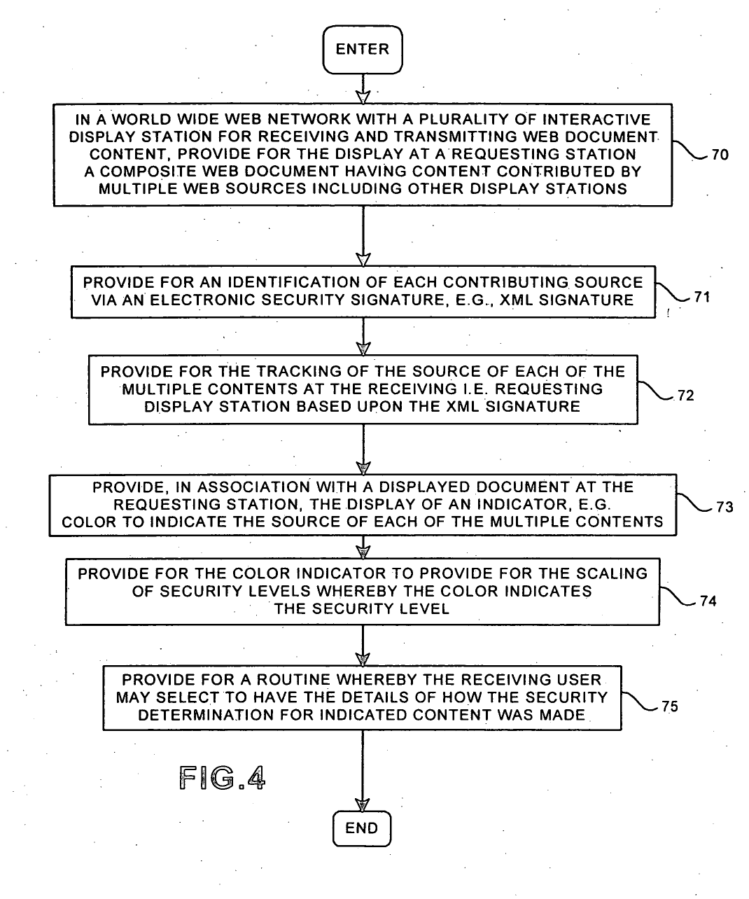

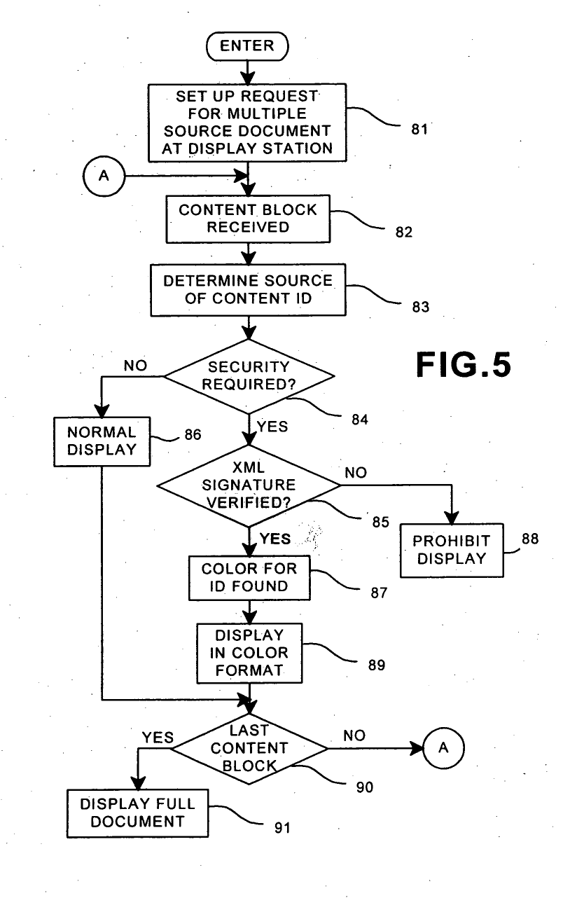

Within this environment, Web Services distribution has evolved in recent years. Web Services are based on both suppliers of the data in the form of XML based messages and documents and applications consuming such data conforming to several industry standards developed by the W3C. The primary standard is XML (Extended Markup Language) for defining data and creating markup languages in the form of XML tags. The resulting XML documents are text based and, thus, may be processed on any platform in the distribution of the Web Services. In light of this background, reference is made to FIG. 2 showing a portion of the Web or Internet set up for the distribution of text based data. Thus, data content in the form of HTML or XML document portions may be transmitted over the Web and entered into receiving Web documents at receiving Web display stations. For purposes of the present embodiment, let computer station 56, FIG. 2, serve as a typical Web display station for receiving or sending Web documents. As will be described hereinafter with respect to the display interface of FIG. 3 and the program of FIGS. 4 and 5, the Web documents having the multiple contents are displayed on computer display station 56, and the multiple contents are defined therein by the color indicators. Then, under the control of any conventional Web browser 53 in computer 56, the selected multiple data contents from multiple sources are combined into composite Web documents from sources on the Web. The portion of the Web shown has four participating Web display stations 56, 45, 46 and 48, with the latter three having associated databases 55, 57 and 58. For purposes of this illustration, we are displaying the composite Web document with multiple content from multiple sources at Web display station 56 under control of Web browser program 53 operating via a conventional Web server system 51, via the Web 50 to any of the multiple content from any of databases 55, 57 and 58, respectively, associated with Web display stations 45, 46 and 48 or from input made by users at any of terminals 45, 46 and 48.

It will also be understood that instead of any conventional Web server, system 51 may replaced by a server system of a service provider 47 that will conventionally perform this Web server function along with other Web service provider functions. Thus, the composite Web document with content contributions from the multiple display stations 56, 45, 46 and 48 or associated databases 55, 57 and 58 is to be displayed at display station 56 in the format shown in FIG. 3. This composite Web document with multiple content from multiple sources could also be selectively displayed on any of Web display stations 45, 46 or 48.

With reference to FIG. 3, the display screen 60, as shown, has a displayed text document at the stage where there have been contributions of content to the document from multiple sources: police report having a border 61; defendants's remarks having a border 62; the district attorney having a border 63; and defendants attorney having border 64. This is only one illustrative page in what could be a very lengthy document. Each of borders 61, 62, 63 and 64 will have a different distinct colors so that as the viewing user goes through the Web document, the continuous specific color pattern will be apparent to the user in distinguishing the data content contribution from each of the contributing sources will be apparent throughout. The additional advantage of the present invention is that the visual indicia, such as color, could be used to indicate the security status or level of the segment of the multiple content or the source of such a segment. It is outside of the scope of the present invention to try to define or describe various processes for determining the security status of document content. However, once the security status of a content or its source is determined, then the present invention may be used to distinguish this status via color or other visual indicia.

However, by way of background, electronic signatures are one accepted way of determining security status. Electronic signatures are used in the transmission and opening of markup language, e.g. HTML documents to indicate the security of the content. The current standard electronic HTML security signature is the XML (Extended Markup Language) signature that is defined by W3C standard for XML signatures. Some defined requirements for XML signatures are: The signature must be based on an RDF (Resource Description Framework) Model; the signature must apply to any resource addressable by a locator—including non-XML content; references are identified with XML indicators; the signatures must be applicable to a part or the totality of the XML document; multiple XML signatures must be able to exist over the static content of a Web resource given varied keys, content transformations and algorithm specifications; XML signatures are first class objects themselves and consequently must be able to be referenced and signed; the specification must permit the use of varied digital signature and message authentication codes, such as symmetric and asymmetric authentication schemes, as well as dynamic agreement of keying material.

Now, with reference to FIGS. 4 and 5, we will describe a process implemented by the present invention in conjunction with the flowcharts of these figures. FIG. 4 is a flowchart showing the development of a process according to the present invention for coordinating content from multiple sources into a hypertext Web document at a display station so that each of the multiple contents is distinctly defined by a visual indicator, e.g. color, and further provision is made for signature security.

In a Web network with a plurality of interactive display stations for receiving and transmitting Web document content, provision is made for the display at an appropriate requesting station of a composite Web document having content contributed from multiple Web sources including databases and other display stations, step 70. There is a set up using standard XML protocols for identifying each contributing source via its electronic security signature: its XML signature, step 71. Provision is made for the tracking of the source of each of the multiple contents at the requesting receiving display station based upon the XML signature, step 72. Provision is made for the display, in association with the displayed Web document at the requesting station, of an indicator, such as a distinct color, to indicate the source of each of the multiple contents, step 73. Provision may be made so that a color indicator may be scaled so that the color also indicates the security level, step 74. Also, provision is made for the situation wherein the user at the receiving station may be concerned and want to verify the basis for a security color designation. In such a case, an implementation is provided whereby the receiving user interactively selects to have further details, e.g. the user may use a mouse pointer to click on the color frame enclosing a content segment. This will result in the display of details such as how the security status of the content was determined, step 75.

An illustrative run of the process set up in FIG. 4 will now be described with respect to FIG. 5. First, step 81, a request is set up and sent from a receiving display station, via its Web browser, for a Web document that will have content contributed from multiple sources, step 81. A block of content is then received, step 82, and the source of the content is determined via the content identifier, step 83. A determination is then made as to whether any indication of security is required, step 84. If No, the content is displayed normally without any indicator, step 86. If Yes, then a further XML signature verification is made, step 85. If there is No verification, the display is prohibited and appropriate notification may be given to the user, step 88. If Yes, the security XML signature is verified, then the color for the ID of the content block is located on an appropriate stored table, step 87, and the content block is displayed with its associated color indicator, step 89. At this point and after step 86, a determination is made, step 90, as to whether the received and processed content block was the last in the document. If Yes, the complete document is displayed, step 91. If No, the process is Branched via “A” to step 82 where the processing is continued with the next received content block.

Although certain preferred embodiments have been shown and described, it will be understood that many changes and modifications may be made therein without departing from the scope and intent of the appended claims.

What is claimed is:

1. In a communication network with user access via a plurality of data processor controlled interactive network display stations, a system for creating markup language documents having multiple contents respectively from multiple sources comprising:
means for providing multiple contents for a created markup language document from a plurality of sources including said interactive display stations;
means for tracking the source of each of said multiple contents in said created markup language document;
means for displaying said created markup language document at an interactive network display station; and
means for showing the source of each of said multiple contents in said displayed markup language document by a non-alphanumeric visual indicator.

2. The system for creating network markup language documents of claim 1 wherein said visual indicator is a specific color.

3. The system for creating network markup language documents of claim 1 wherein said visual indicator shows the source of at least one of said multiple contents based upon the security level of the source.

4. The system for creating network markup language documents of claim 3 wherein said security level of the source is determined through the electronic signature of the source content.

5. The system for creating network markup language documents of claim 4 further including means responsive to an interactive selection of the visual indicator showing a content source for displaying the details defining the security level of said source.

6. The system for creating network markup language documents of claim 4 wherein said network is the World Wide Web and said document is a HTML document.

7. The system for creating network hypertext documents of claim 6 wherein said electronic signature of said HTML document is created with XML protocols and said electronic signature is an XML signature.

8. In a communication network with user access via a plurality of data processor controlled interactive network display stations, a method for creating markup language documents having multiple contents respectively from multiple sources comprising:
providing multiple contents for a created markup language document from a plurality of sources including said interactive display stations;
tracking the source of each of said multiple contents in said created markup language document;
displaying said created markup language document at an interactive network display station; and
showing the source of each of said multiple contents in said displayed markup language document by a non-alphanumeric visual indicator.

9. The method for creating network markup language documents of claim 8 wherein said visual indicator is a specific color.

10. The method for creating network markup language documents of claim 8 wherein said visual indicator shows the source of at least one of said multiple contents based upon the security level of the source.

11. The system for creating network markup language documents of claim 10 wherein said security level of the source is determined through the electronic signature of the source content.

12. The method for creating network markup language documents of claim 11 further including means responsive to an interactive selection of the visual indicator showing a content source for displaying the details defining the security level of said source.

13. The method for creating network markup language documents of claim 11 wherein said network is the World Wide Web and said document is an HTML document.

14. The method for creating network markup language documents of claim 13 wherein said electronic signature of said HTML document is created with XML protocols and said electronic signature is an XML signature.

15. A computer program having code recorded on a computer readable medium for creating markup language documents having multiple contents respectively from multiple sources in a communication network with user access via a plurality of data processor controlled interactive network display stations, said computer program comprising:
means for providing multiple contents for a created markup language document from a plurality of sources including said interactive display stations;
means for tracking the source of each of said multiple contents in said created markup language document;
means for displaying said created markup language document at an interactive network display station; and
means for showing the source of each of said multiple contents in said displayed markup language document by a non-alphanumeric visual indicator.

16. The computer program for creating network markup language documents of claim 15 wherein said visual indicator is a specific color.

17. The computer program for creating network markup language documents of claim 15 wherein said visual indicator shows the source of at least one of said multiple contents based upon the security level of the source.

18. The computer program for creating network markup language documents of claim 17 wherein said security level of the source is determined through the electronic signature of the source content.

19. The computer program for creating network markup language documents of claim 18 wherein said network is the World Wide Web and said document is a HTML document.

20. The computer program for creating network hypertext documents of claim 19 wherein said electronic signature of said HTML document is created with XML protocols and said electronic signature is an XML signature.
